(19) United States
(12) Patent Application Publication
(10) Pub. No.: US 2008/0169258 A1
(43) Pub. Date: Jul. 17, 2008

(54) Vehicle Mounted Crane

(75) Inventor: Thomas Weisbauer, Bietigheim-Bissingen (DE)

Correspondence Address: BIRCH STEWART KOLASCH & BIRCH, PO BOX 747, FALLS CHURCH, VA, 22040-0747, US

(73) Assignee: Manitowoc Crane Group Germany GmbH, Wilhelmshaven (DE)

(21) Appl. No.: 11/792,062

(22) PCT Filed: Dec. 1, 2005
(86) PCT No.: PCT/EP05/12852

§ 371 Date: Jan. 8, 2008

(30) Foreign Application Priority Data
Dec. 3, 2004 (EP) 04028739.3

(51) Int. Cl. B66C 23/42; B66C 23/24; B66C 23/74; B66C 23/82; B66C 23/78; B66C 23/16

(52) U.S. Cl. 212/296; 212/347

(57) ABSTRACT

The invention relates to a vehicle crane, especially a mobile crane, automobile crane, or track-laying crane, comprising a superstructure which is embodied as a top slewing crane and encompasses a vertical tower and a boom located on the tower

The invention relates to a vehicle mounted crane, in particular a mobile, self-propelled or crawler crane.

In crane technology, a distinction is commonly made between categories on the basis of tower slewing cranes or tower cranes on the one hand and vehicle mounted cranes on the other hand.

Tower slewing cranes have a vertical tower standing on a sub-structure, which is usually provided in the form of a lattice framework, and—although they can be moved by means of a track system on building sites for example—they are not designed to operate as vehicles which can move in normal road traffic. Vehicle mounted cranes, on the other hand, are self-driving road vehicles and are designed precisely for mobile applications.

Vehicle mounted cranes comprise an undercarriage incorporating the bogie and a top carriage which is able to rotate on the undercarriage and comprises a stewing unit and a jib. The jib may be a telescopic jib based on a box-type design or a lattice mast boom.

Increasingly tougher demands are being placed on cranes and are so both in terms of carrying strength and lifting capacity as well as the height to which the loads have to be lifted.

One application in which cranes are becoming increasingly important is that of erecting wind turbines because there is a growing trend towards higher performance wind turbines, which not only require higher but also heavier components.

Amongst the problems of erecting wind turbines by means of cranes are the associated logistics and not least the practically unavoidable damage to the ground, incurring high costs because, due to the immense total weight of the crane, a number of individual trips have to be made carrying heavy loads to the site of wind turbines, which are usually in remote locations, before the types of existing cranes used for erecting large wind turbines can be erected.

The objective of the invention is to propose a vehicle mounted crane specifically suitable for erecting wind turbines, which is of as low a weight as possible and can be made ready for operation as quickly as possible in order to reduce the cost of using a crane to a minimum, but without reducing the carrying power or lifting capacity.

This objective is achieved on the basis of the characterising features defined in claim 1 and in particular due to the fact that the vehicle mounted crane is provided with a structure in the form of a top-slewing system comprising a vertical tower and a jib on the tower.

The concept proposed by the invention based on a top-slewing structure with a vertical tower and a jib fitted on it constitutes a departure from the construction principle adopted for vehicle mounted cranes in the past, whereby the slewing system is disposed on a level with the bogie, and the mast, which is usually telescopic or in the form of a lattice frame, is inclined with respect to the vertical and is provided with a counter-weight which rotates with it in order to achieve the necessary stability and prevent overturning in every operating position. This is referred to as the crane radius. In the case of the vehicle mounted crane proposed by the invention, such a crane radius which has been typically necessary for vehicle mounted cranes does not exist due to the vertical tower.

Surprisingly, it has been found that the concept proposed by the invention based on a non-rotating vertical tower offers a number of advantages. In particular, because there is no crane radius and no counter-measures in the form of heavy counter-weights are needed, a crane with a relatively low overall weight—by reference to the carrying strength or lifting capacity—can be obtained, which has a positive effect on mobility because only a relatively small number of individual trips is needed.

Designing the vehicle mounted crane with a top-slewing system as proposed by the invention also opens the way for advantageous options for additionally securing or stabilising the tower if necessary and also provides a particularly simple concept for erecting the tower. This will be explained in more detail below.

Advantageous embodiments of the invention will also become apparent from the dependent claims, the description and the drawings.

The jib is preferably inclined with respect to the tower. This should also be construed as meaning a horizontal extension, i.e. a jib extending perpendicular to the tower.

The jib is also preferably such that its length can be adjusted and/or its angle relative to the tower can be adjusted. To enable a length adjustment, the jib is preferably of a telescopic design.

In an example of another preferred embodiment, the jib is an integral part of a component unit which can be transported as a whole in particular and in addition to the jib comprises a slewing unit, a luffing system, a block and pulley with a bottom block and top roller pulley and optionally a crane driver's cab, as well a all the drive units needed for this equipment. To this extent, this component unit incorporating the jib may be termed a top carriage, although the term “top carriage” as used in connection with conventional vehicle mounted cranes refers to the entire structure fitted directly on the bogie, also referred to as the under-carriage.

As proposed by the invention, it is also preferable if the tower is of an adjustable length. The tower is preferably provided in the form of a telescopic tower.

In another example of a preferred embodiment of the invention, the intrinsic weight of the tower is provided as a counter-weight. Unlike conventional vehicle mounted cranes in which the mast is always inclined at an angle due to the crane radius and a counter-weight has to be provided, which significantly increases the overall weight of the crane, such an additional counter-weight can be dispensed with in the case of the vehicle mounted crane proposed by the invention, even at a high carrying strength or lifting capacity. It has been found that the stability of the vertical tower, which may be additionally secured if necessary, is sufficient, i.e. the stability of the vehicle mounted crane proposed by the invention is already at least essentially guaranteed by the intrinsic weight of the tower; the vertical tower acts as a central ballast of the vehicle mounted crane.

Depending on the specific dimensioning of the vehicle mounted crane proposed by the invention, additional securing and stabilisation features may be provided for the tower, which will be discussed in more detail below. However, such features contribute to the overall weight of the crane, albeit to a significantly lesser degree than is the case with the counter-weights used with conventional vehicle mounted cranes. The option of working with one or more additional counter-weights in conjunction with the vehicle mounted crane proposed by the invention is not ruled out, however, especially at very high loads or radii. Such counter-weights might be at least one auxiliary vehicle or auxiliary crane coupled with the bogie of the vehicle mounted crane proposed by the invention for this purpose in any event, for example.

As also proposed by the invention, a stabiliser system is provided for the tower. The stabiliser system preferably comprises a plurality of base stabilisers distributed around the tower.

The natural weight of the tower and the stabiliser system may be adapted to one another, thereby obviating the need for an additional counter-weight.

In an example of another preferred embodiment of the invention, an anchoring system is provided for the tower. The bending resistance of the tower can be increased by using an anchoring system because an anchoring system acting on the tower at a specific height reduces the effective length L of the tower taken into account when calculating the critical bending load on the basis of 1/L².

The anchoring system preferably comprises a plurality of anchoring elements distributed around the tower, each of which is specifically provided in the form of a guy anchor.

The possibility of imparting a significantly higher load bearing capacity to the tower by means of an anchoring system is one of the advantages of the concept proposed by the invention whereby a structure with a vertical tower is provided in the form of a top-slewing system, because it is not possible to use an anchoring system with a structure which rotates at the bottom.

If the tower is a telescopic tower, it is preferable if the anchoring system acts on one or more tower segments, also referred to as boxes or segments. It is of particular advantage to provide an anchoring system on several tower segments and thus at points spaced apart along the tower because this results in a particularly high reduction of the effective tower length and thus increases the maximum bending stress which the tower can withstand. This being the case, the anchoring system may act on the region of the top ends of the respective tower segments in particular which are also accessible when the tower is retracted. Within the context of the invention, an anchoring system acting on various positions spaced apart along the tower may be provided, but may also be provided with a non-telescopic tower.

As is the case with another embodiment of the invention, it is of particular advantage if the anchoring system is connected at least partially to a tower stabiliser system. Additional ground anchoring or other anchoring for the anchoring system can be dispensed with as a result, although the invention does not exclude the possibility of using other anchoring systems as an alternative to or in addition to an anchoring system on the tower stabiliser system.

In another preferred embodiment of the invention, an active anchoring system is provided for the tower, which can be activated depending on load-induced bending moments acting on the tower in order to compensate these bending moments.

An active anchoring system of this type therefore makes it possible to react specifically to a load occurring on the tower during operation of the crane because the anchoring system is activated so that the bending moment acting on the tower is compensated.

This being the case, it is preferable if the anchoring system is used in a cross-shaped or star-shaped disposition by reference to the tower axis, although other anchoring geometries or configurations could also be used in principle.

A control and/or regulating unit is preferably provided, which determines the degree and direction of any compensation which might be needed during operation of the crane and activates the anchoring system accordingly.

This makes it possible to react both to changes in the size of the load and changes occurring in the direction of the load-induced bending moment immediately, especially when the jib is rotating, by activating the anchoring system accordingly.

The control and/or regulating unit may have an inclination sensor for determining the inclination of the tower. This being the case, the inclination of the tower axis can be detected relative to the vertical or a to tower platform, or a tower head or a reference plane of a top carriage can be detected relative to the horizontal. If necessary, the reference orientations (vertical or horizontal) can be corrected, for example in order to make allowance for unevenness in the ground or sinking of a base stabiliser for example. The anchoring system may be activated in such a way that it always tries to maintain a pre-defined inclination of the tower, and in particular is distinctive due to the fact that a platform of a top carriage of the crane is disposed in a horizontal orientation.

The anchoring system preferably acts on the tower by means of tensile forces in order to compensate for load-induced bending moments. This being the case, the anchoring system may act on the tower on the one hand and on a tower stabiliser system on the other hand.

In a preferred embodiment of the invention, the anchoring system comprises a plurality of anchoring elements distributed around the tower, which can be activated independently of one another. Irrespective of the rotational position of the crane, this makes it possible to react to a bending moment acting in any direction by activating the anchoring system accordingly. The anchoring elements are preferably cross-shaped or star-shaped, although in principle any disposition is possible and is specifically selected as a function of tower stabiliser on which the anchoring system acts, and which may be “H”-shaped, for example.

In another embodiment of the invention, it may be that the anchoring elements do not act directly on the tower or, in the case of a telescopic tower, on a tower segment, and instead, a jib projecting out from the tower is provided for each anchoring element, by means of which the anchoring element acts on the tower. Each of these jibs may constitute part of the lattice.

In one particularly practical embodiment of the invention, the tower is of a telescopic design and the tower stabiliser system comprises a plurality of base stabilisers, which are disposed in a cross-shaped or star-shaped pattern in particular, and a plurality of anchoring elements of the anchoring system respectively act on a tower segment on the one hand and on a base stabiliser on the other hand.

It is preferable if every anchoring element is provided with a tensioning system, in particular a tensioning cylinder, which is disposed between the anchoring element and the tower or between the anchoring element and a tower stabiliser.

Every tensioning system is provided with a distance measuring system, by means of which the position of the tensioning unit can be determined by reference to a pre-defined base position.

As also proposed by the invention, the jib is provided with a counter-jib. The counter-jib is preferably adjustable so that the bending moment by means of which it acts on the tower can be varied. To this end, the counter-jib may be length-adjustable in particular, for example of a telescopic design, and/or may be designed so that its angle relative to the tower can be adjusted.

Providing a counter-jib means that load-induced bending moments—i.e. acting on the tower via the jib supporting the load to be lifted—can be at least partially compensated. In particular, this enables the tower to be kept at least largely free of bending moments.

In one example of a particularly preferred embodiment, a control and/or regulating unit is provided, by means of which the counter-jib can be adjusted as a function of the load moment at any time. As a result, the tower can also be kept always essentially free of bending moments during crane operation in the event of changes in the load situation on the jib by automatically changing the counter-jib setting in response to changes in the load situation on the jib, for example by adjusting the length or angular positioning relative to the tower.

In an example of another embodiment of the invention, a tower mount is provided for the bottom end of the tower, which is pot-shaped or cup-shaped in particular and connects two bogie parts spaced apart from one another. As a result, the tower mount constitutes an integral part of the bogie. When the tower is in the transport position, its bottom end is preferably separated from the tower mount. This separation between tower and tower mount permits transportation with the tower lying on the bogie.

It is also preferable if the tower mount is connected to a tower stabiliser system. This enables the tower mount to be simultaneously used as a means of support for it.

As also proposed by the invention, the tower is of a self-erecting design. This being the case, in a preferred embodiment of the invention, at least two length-adjustable adjusting mechanisms are provided as a means of erecting the tower, which act on positions spaced apart along the tower.

In particular, the tower can be transferred by means of a first adjusting mechanism acting at a distance from the bottom end of the tower from an essentially horizontal transport position into an inclined position and by means of a second adjusting mechanism acting in the region of the bottom end of the tower from the inclined position into the vertical working position. This being the case, it is preferable if the tower is forcibly guided in the region of its bottom end, and is so in particular in an at least approximately horizontal direction.

The erection principle proposed by the invention, whereby the tower is not merely pivoted about an axis which remains stationary relative to the bogie but a preferably horizontally extending translating movement is also superimposed on the pivoting movement of the tower, advantageously means that the transport position of the tower by reference to the bogie can be optimally adapted to transport requirements without the position of the bottom end of the tower desired or needed for the vertical working position having to be fixed.

The fact that mechanisms which might be termed “on-board” to a certain extent are provided for erecting the tower does not rule out the option of erecting the tower assisted by an external auxiliary mechanism, in particular in the form of an auxiliary crane, especially if the vehicle mounted crane proposed by the invention is designed for very high lifting capacities.

In an example of another preferred embodiment of the invention, the tower may be erected with the jib fitted. Depending on the dimensions of the tower and the jib, the tower may be erected with the jib fitted, either solely on the basis of its own force or assisted by external auxiliary mechanisms.

It is particularly preferable if, as in the case of another embodiment of the invention, a retaining mechanism in the form of a rigid steering arm in particular is provided, which holds the angularly adjustable jib fitted on the tower in an at least approximately horizontal position during the erection operation, irrespective of the inclination of the tower. As a result, the tower ensures, essentially of its own accord, that the fitted jib remains in a respective desired position relative to the bogie at least within certain limits during the process of erecting the tower in spite of the increasing size of the angle between the tower and the jib. This desired position of the jib may also vary from a horizontal position, although an essentially horizontal orientation of the jib is preferred.

In another preferred embodiment of the invention, the tower disposed on the bogie provided in the form of a flat-bed lorry in particular on the one hand and the jib, in particular the top carriage incorporating the jib, on the other hand, are provided with separate transport units, each of which is specifically authorised for driving on the roads.

It has been found that, based on the concept proposed by the invention, it is sufficient if the tower and jib or top carriage are each of dimensions authorised for road transport as a whole in keeping with current traffic regulations. Any crane components optionally provided in addition, such as tower stabiliser system, tower anchoring system and a retaining mechanism used to assist the erection operation, may be grouped in another single transport unit.

The vehicle mounted crane proposed by the invention can therefore be transported in road traffic with only three individual transport units due to its low overall weight relative to its carrying force or lifting capacity. This means that the logistics involved in transporting it to the respective deployment site are reduced to a minimum, and at the same time a minimum amount of space is required on site during the erection operation with a relatively low risk of damage to the ground.

As a result of the invention, therefore, the costs incurred by the use of a crane in the past can be significantly reduced, especially for erecting large wind turbines.

The invention will be described on the basis of examples below, with reference to the appended drawings. Of these:

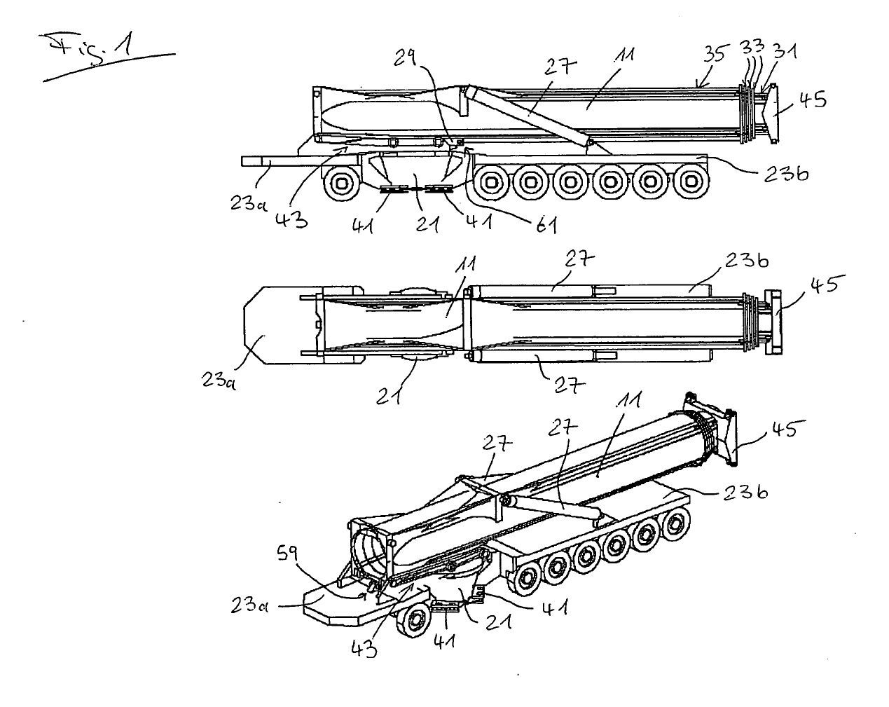

FIGS. 1-7 illustrate an example of an embodiment of a vehicle mounted crane proposed by the invention in different phases of erection,

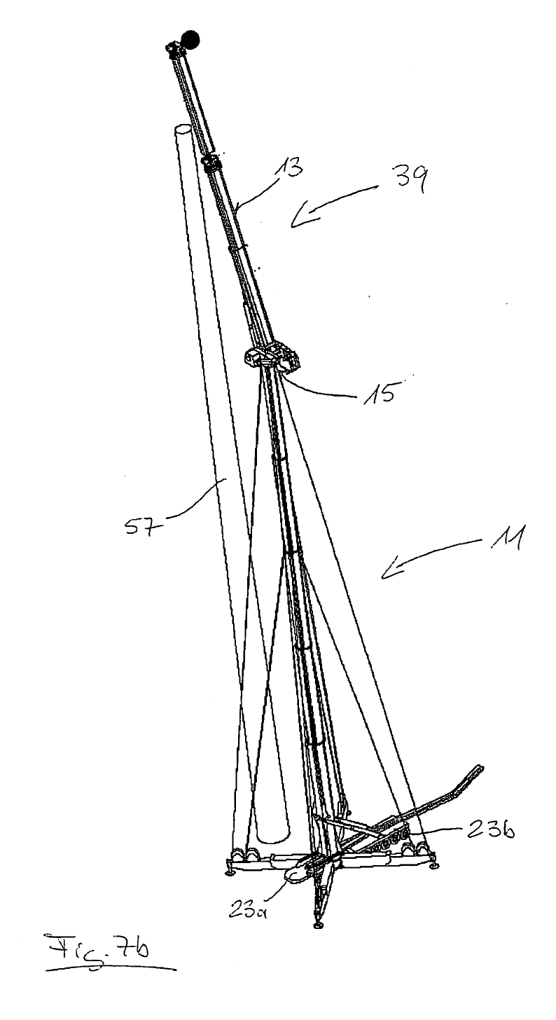

FIG. 8 illustrates an example of another embodiment of a vehicle mounted crane proposed by the invention,

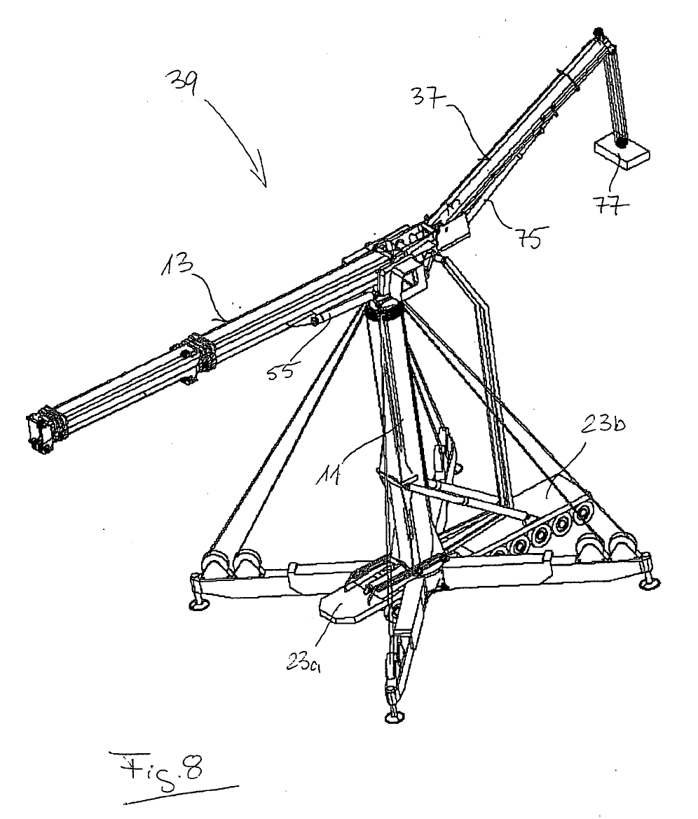

FIG. 9 shows a variant of the vehicle mounted crane illustrated in FIG. 8, and

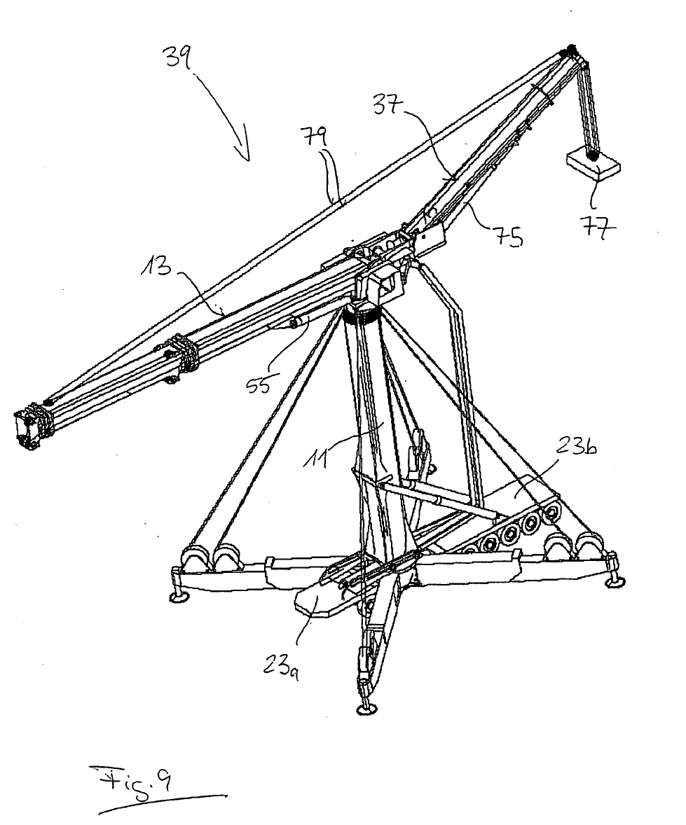

FIGS. 10-13 illustrate an example of another embodiment of a vehicle mounted crane proposed by the invention in different phases of erection.

FIG. 1 shows three different views of part of a vehicle mounted crane proposed by the invention. The part illustrated in FIG. 1 is part of a first transport unit authorised to drive on the roads, comprising an articulated lorry, not illustrated, and a bogie with a front bogie part 23a which can coupled with the articulated lorry and a rear bogie part 23b. A pot-shaped tower mount 21 connecting the two bogie parts 23a, 23b to one another is fixedly integrated in the bogie.

The tower mount 21, which is provided with a plurality of connection points 41 for mounting a tower stabiliser system, which will be described in more detail below, is used to accommodate the bottom end of a tower 11, which is illustrated in its lying-down transport position in FIG. 1. In this transport position, the tower 11 extends transversely beyond the tower mount 21 and lies on the bogie 23a, 23b.

The tower 11 is telescopic and in the embodiment illustrated as an example here comprises five tower segments 31, 33, 35, also referred to as boxes or sections, namely a bottom tower segment or outer box 35 and four inner tower segments or inner boxes 31, 33, and the inner tower segment 31 lying at the very top has a head 45 on its free end, on which a component comprising a jib can be fitted, hereafter also referred to as top carriage, although this not illustrated in FIG. 1.

Two adjusting mechanism 27, 29, which will be described in more detail later, are used to erect the tower 11, which will also be described in more detail later.

A first adjusting mechanism 27 comprises a piston/cylinder pair, which is pivotingly linked on the one hand to the rear bogie part 23b and on the other hand to a point on the bottom tower segment 35 at a distance from the bottom tower end, and is so by its top face remote from the bogie in the lying-down transport position.

A second adjusting mechanism 29 comprises a piston/cylinder arrangement extending essentially parallel with the lying-down tower 11, the cylinder of which is linked by a front end to a fixing point 59 on the front bogie part 23a. In the retracted state, the front end 61 of the piston of the piston/cylinder arrangement 29 lies in the region of the rear end of the tower mount 21. By means of a tensioning linkage in the form of a yoke, not illustrated in FIG. 1, the front piston end 61 is connected to the bottom tower end, and is so on the bottom face directed towards the bogie in the transport position illustrated. The bottom tower end can therefore be pulled backwards and across the tower mount 21 by extracting the piston, as will be explained in more detail below.

Although not illustrated in FIG. 1, a retaining mechanism in the form of a rigid steering arm is provided as a means of erecting the tower 11 and will likewise be explained in more detail below. The steering arm is attached to the front piston end 61 by one end and its other end supports the top carriage positioned on the head 45 as the tower 11 is being erected.

An essentially horizontally extending forced guiding element 43 is also provided for the bottom tower end, which comprises two slots or elongate holes extending parallel at a distance apart in which the bottom tower end locates from the inside by means of co-operating guide projections.

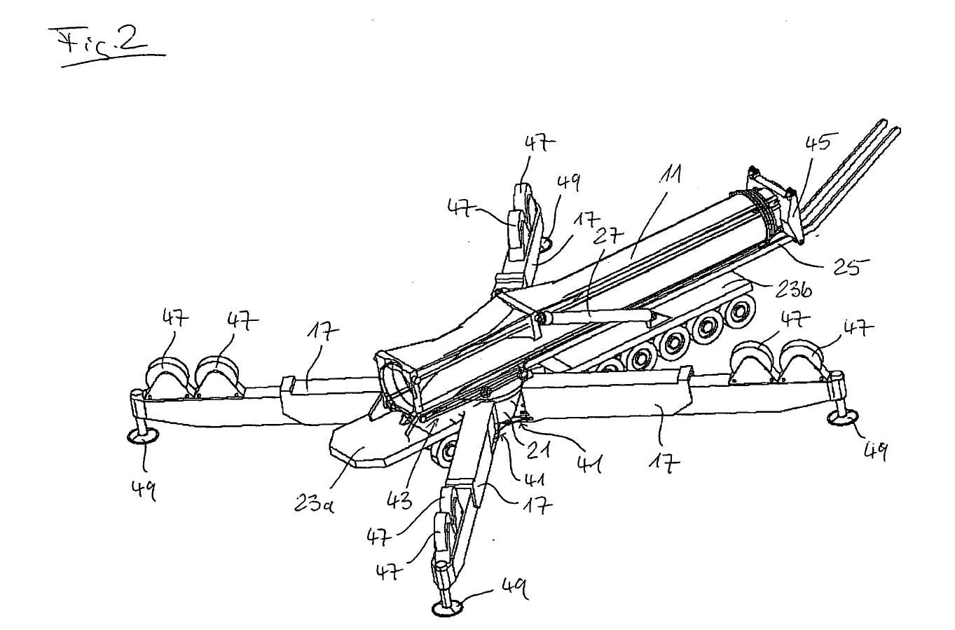

FIG. 2 illustrates the steering arm 25 mentioned above, in the mode connected to the front piston end 61. The steering arm 25 extends parallel with the tower 11 and is angled upwards at its end region projecting above the head 45 when the tower 11 is retracted.

FIG. 2 also illustrates four extractable base stabilisers 17 forming a star-shaped stabiliser system for the vehicle mounted crane and its tower 11.

The base stabilisers 17 are connected to the tower mount 21 at the connection points 41 already mentioned above. At their end regions remote from the tower mount 21, the base stabilisers 17 are each provided with a stabiliser foot 49 on the one hand and two winches 47 at the top, which have a brake mechanism based on a pawl or catch principle, for example. The winches 47 are part of a tower anchoring system which will be explained in more detail below.

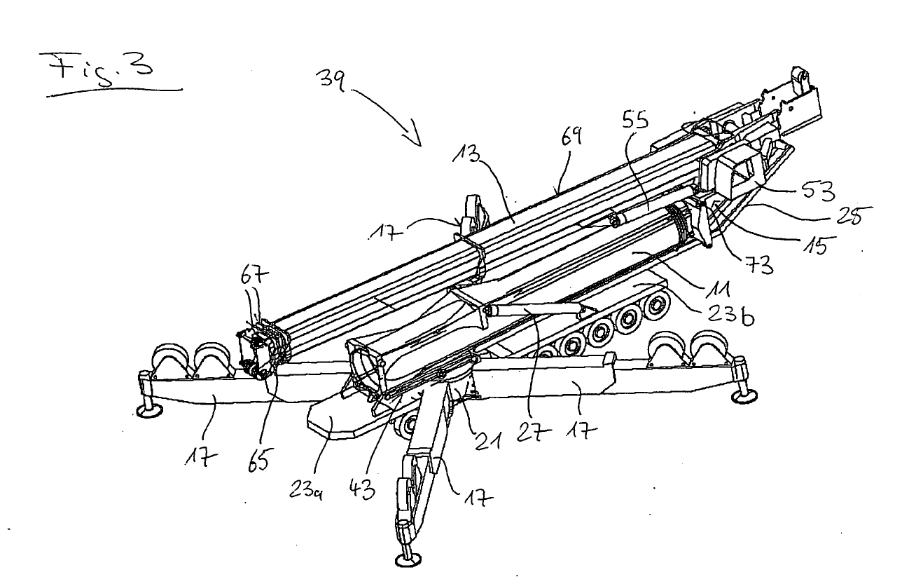

FIG. 3 illustrates the vehicle mounted crane proposed by the invention with the top carriage 39 fitted. The top carriage 39, which is transported by a different lorry, not illustrated, and thus co-operates with a second transport unit authorised for driving on the roads, has a jib 13 comprising a telescopic mast with four mast segments 65, 67, 69 in the embodiment illustrated as an example here, namely a top mast segment 65 with a bottom block and pulley, two other inner segments or inner boxes 67 and a bottom mast segment 69, which is connected to a luffing unit 55 and stewing unit 15. In addition to the jib 13, the top carriage 39 in the embodiment illustrated as an example here has a crane driver's cab 53, the drive units for the stewing unit 15 and the luffing unit 55 as well as hoists.

The rigid steering arm 25 is pivotingly linked by the free end of its angled end region to the rear end region of the top carriage 39.

In the position illustrated in FIG. 3, the top carriage 39 is articulatingly linked to the head 45 by one end only so that it can pivot about an axis 73, thereby permitting an angular displacement between the top carriage 39 and jib 13 on the one hand and the tower 11 on the other hand when the tower 11 is being erected, as will be described below.

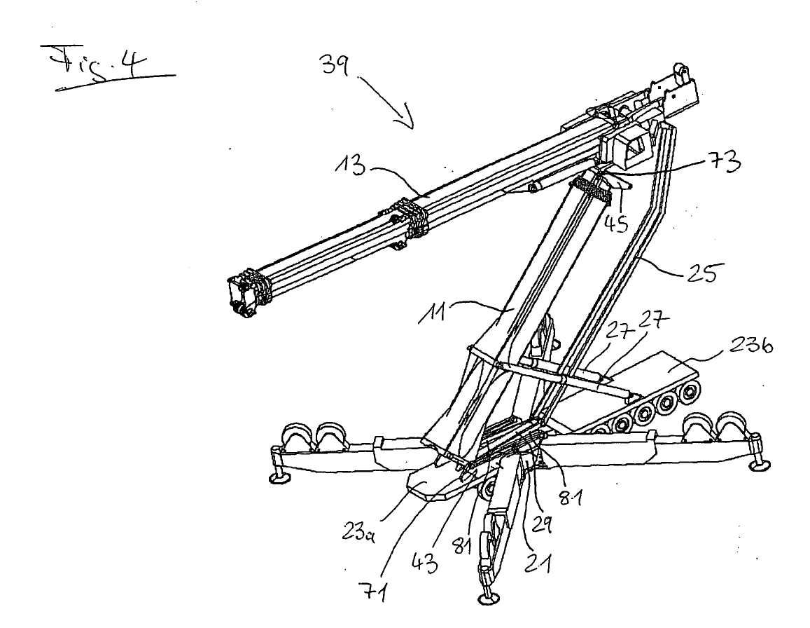

In order to erect the tower 11 with the top carriage 39 fitted, the tower 11 is firstly transferred from its horizontal transport position by means of the first adjusting mechanism 27 into the inclined position in which the tower 11 is inclined at approximately 45° with respect to the vertical, as illustrated in FIG. 4, for example. Up to this point, the movement by which the tower 11 is erected is a pure pivoting movement about an axis 71 at the one end of the forced guiding element 43 for the bottom tower end. In the position illustrated in FIG. 4, the second adjusting mechanism 29 is therefore still in the retracted state. FIG. 4 illustrates the tensioning rod linkage or yoke 81, which is largely covered in FIGS. 1 to 3.

The rigid steering arm 25 always holds the jib 13 in an at least essentially horizontal position, in spite of the changing inclination of the tower as it is being erected. In order to obtain forces and moments conducive to erecting the tower 11, the inner segment packet of the telescopic mast of the jib 13 illustrated in FIG. 4 is extracted, as a result of which the centre of gravity of the jib 13 or top carriage 39 is shifted to the front, away from the pivot axis 73 between the top carriage 39 and tower 11.

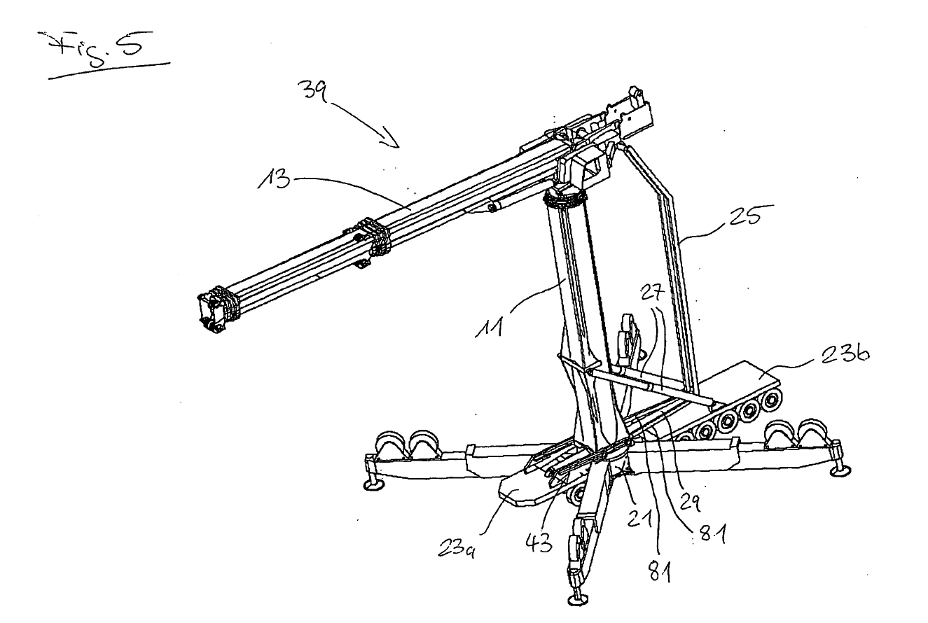

In the state illustrated in FIG. 5, the tower 11 is in the fully erected state in which it extends in the vertical direction. The tower 11 is transferred from the inclined position illustrated in FIG. 4 into the working position by means of the second adjusting mechanism 29 by extracting the piston, so that on the one hand the bottom tower end is pulled by means of the tensioning rod linkage or yoke 81 onto the tower mount 21, on which the bottom tower end is then secured, for example by bolting, and the bottom end of the rigid steering arm 25 is likewise pushed backwards—by reference to the driving direction of the bogie—on the other hand.

The positions of all the pivot axes relative to one another actively involved in erecting the tower 11 as well as the lengths of all the components involved are adapted to one another as proposed by the invention so that the controlling movement transmitted by the tower 11 as it is being erected via the steering arm 25 to the top carriage 39 pivotably mounted on the tower 11 always holds the top carriage 39 in the at least essentially horizontal desired position during the entire erection operation and thus irrespective of the tower inclination.

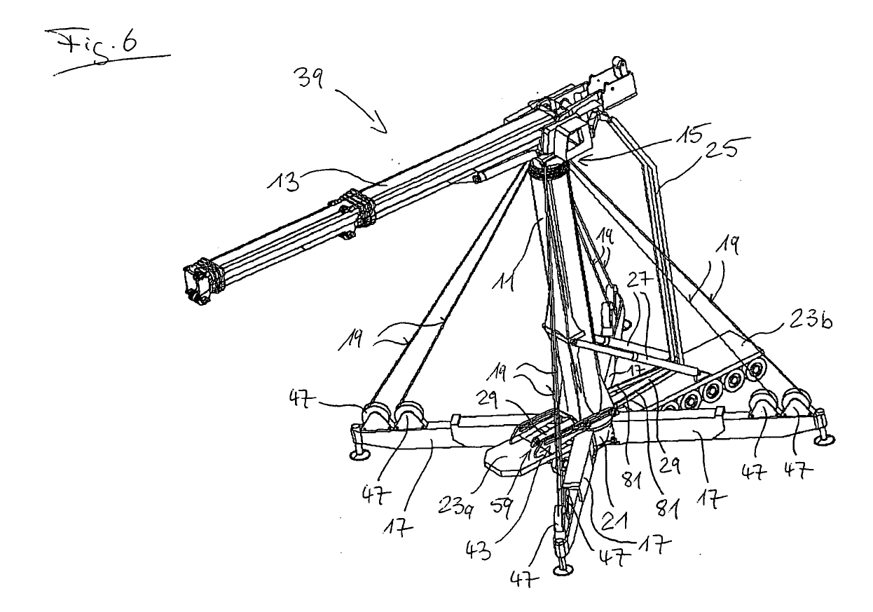

Once the tower 11 has been transferred to the vertical working position, a star-shaped anchoring system 19 is fitted, as illustrated in FIG. 6. With the telescopic tower 11 still retracted, two guy anchors 19 are wound on the winches 47 attached to the base stabilisers 17 for each of the four base stabilisers 17, with their free ends attached to different tower segments and specifically in the upper peripheral region of the segment in each case.

Clamping mechanisms for clamping the guys 19 are integrated in the base stabilisers 17.

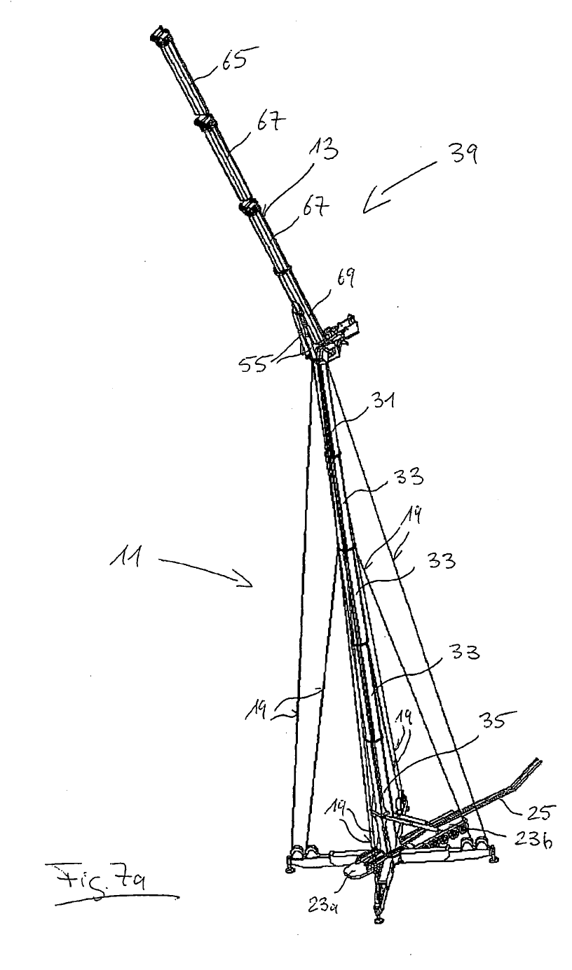

Transferred to the vertical position, supported and anchored in the manner described above after fitting the top carriage 39, the tower 11 can now be telescoped to the respective desired working length by releasing the connection between the rigid steering arm 25 and top carriage 39, as illustrated in FIG. 7a. The guy anchors 19 are unwound from the winches 47 accordingly as the tower height increases and can therefore be constantly held under tension.

At the same time as the tower 11 is being erected or once the respective working length of the tower 11 is reached, the telescopic mast of the jib 13 can be extracted and moved to the desired angular position relative to the tower 11 by means of the luffing unit 55 in order to move the mast tip into the desired working position with regard to height and radius.

The vehicle mounted crane proposed by the invention is thus ready for deployment.

FIG. 7b provides a schematic illustration of the vehicle mounted crane proposed by the invention in the immediate vicinity of a tower 57 of a wind turbine to be erected. A major advantage of the vehicle mounted crane proposed by the invention resides in the fact that because of its vertical tower 11, the crane can be positioned relatively close to the tower 57 of the wind turbine.

FIG. 8 illustrates a vehicle mounted crane that is modified compared with the embodiment described as an example above. The modification is the fact that an additional counter-jib 37 is provided. Like the jib 13, the counter-jib 37 is provided with a telescopic mast and its angle can be adjusted relative to the tower 11 by means of a luffing unit 75. The counter-jib 37 is also provided with a ballast 77 hanging down from its mast tip via a block pulley.

The counter-jib 37 including the ballast 77 is dimensioned so that it can compensate for load-induced bending moments acting on the tower 11 via the jib 13 carrying the load to be lifted by a corresponding counter-moment. Due to its adjustability in terms of length and angle, the counter-jib 37 can be adapted to varying load and moment situations on the jib side.

The vehicle mounted crane proposed by the invention is preferably provided with a device which determines the instantaneous load or the instantaneous moment on the jib 13 by means of an appropriate sensor system and on this basis adjusts the counter-jib 37 so that the tower 11 is held at least largely free of bending moments, i.e. is loaded with pressure in essentially only the vertical direction. This makes it possible to react to jib-side changes by varying the settings on the counter-jib 37 accordingly with practically no delay.

The vehicle mounted crane illustrated in FIG. 9 differs from that illustrated in FIG. 8 solely due to the fact that an additional guy anchor 79 is provided between the jib 13 and the counter-jib 37. The length of the guy anchor 79 can be varied as a function of the angle between the jib 17 and counter-jib 37 and can be so by means of a separate block pulley on the counter-jib 37. The guy anchor 79 relieves strain on the luffing units 55, 75.

The radius of the vehicle mounted crane proposed by the invention can be limited to the amount needed for the respective lifting job and hence to the minimum necessary due to the vertical tower 11. This being the case, the vehicle mounted crane proposed by the invention is not subject to the crane radius needed for conventional cranes. This makes it possible to use the intrinsic weight of the tower 11 as central ballast, at least partially obviating the need for the usual counter-weight used with conventional vehicle mounted cranes and, if necessary, only a relatively low counter-weight can be provided for the stabilisation system 17 of the tower 11. The top-slewing design proposed by the invention means that it is possible to provide the guy anchor 19 by means of which the load bearing capacity of the tower 11 can be increased from the point of view of tolerable bending moments, which in turn makes additional counter-weights superfluous. The standing stability already achieved by the vertical tower 11 itself requires only a relatively low counter-weight for the stabiliser system 17 of the tower 11—if any at all.

With the exception of the differences described below, the other embodiment of a vehicle mounted crane proposed by the invention and illustrated in FIGS. 10-13 corresponds to the embodiments described as examples above. Corresponding components are therefore denoted by the same reference numbers.

The rigid steering arm 25 provided in the embodiments of the vehicle mounted crane described as examples above is replaced by a different retaining system in the other example of an embodiment, namely by two stay cables 87 extending parallel. The stay cables 87 extend between the rear end region of the top carriage 39 and the bottom end of the tower 11. The way in which the stay cables 87 work as the tower 11 is being erected corresponds to that of the rigid steering arm 25. Due to the stay cables 87, the top carriage 39 is always held in an at least essentially horizontal desired position during the entire erection operation and thus irrespective of the tower inclination.

Another difference compared with the embodiments described above is the design of the guy anchor 19. The other embodiment is provided with an active cross-shaped guy anchor 19. It comprises four separate anchoring elements 19, for example in the form of foldable anchoring rods. In the folded transport mode illustrated in FIG. 10, every anchoring rod 19 lies on a base stabiliser 17.

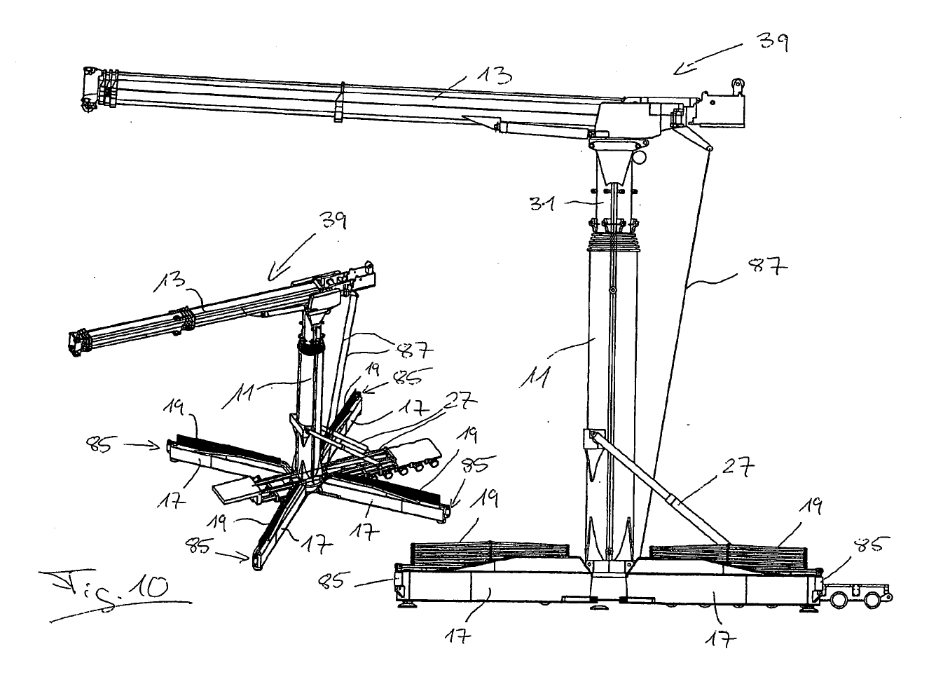

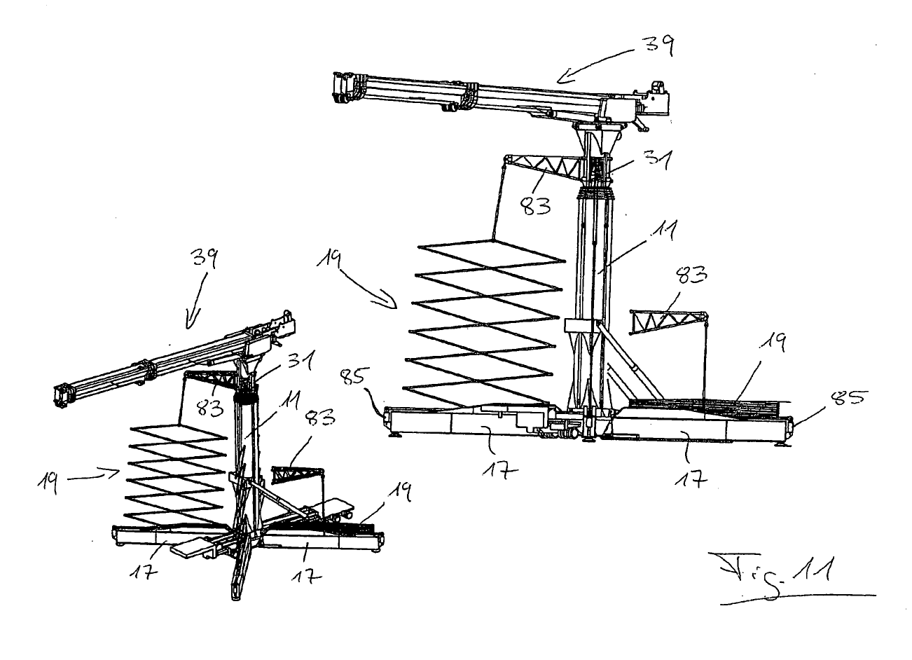

One end of the anchoring rod 19 is coupled with a tensioning cylinder 85 provided at the free end of the base stabiliser 17. The other end of every anchoring rod 19 is free and is attached to the top tower segment 31 during the course of erecting the crane by means of a jib 83 in the form of a lattice part (FIG. 11). Once the tower 11 has been extracted (FIG. 12), the now completely unfolded elongate anchoring rods 19 are respectively moved between a lattice jib 83 attached to the top tower segment 31 and the tensioning cylinder 85 mounted on the co-operating base stabiliser 17.

By operating the tensioning cylinder 85, tensioning forces can be applied via the anchoring rods 19 and the lattice jib 83 to the top end of the tower 11, which then work to “pull” the tower 11 in the direction pre-defined by the matching direction of the relevant lattice jib-base stabiliser pair 83, 17. Due to the cross-shaped or star-shaped disposition of the individual anchoring rods 19, the tower 11 can be pulled in any direction as a result. The tensioning cylinders 85 can be activated separately from one another so that by superimposing all of the tensioning forces acting on the tower 11 by means of the tensioning cylinders 85, a specifically pre-defined tensioning force can be applied to the tower 11 selectively in terms of amount and direction as a result.

For the purpose of the invention, the possibility of applying tensioning forces to the tower 11 is used to compensate load-induced bending moments acting on the tower 11 during operation of the crane.

Although not illustrated, a control and/or regulating unit is provided for this purpose, by means of which the tensioning cylinders 85 can be activated independently of one another. The tensioning cylinders 85 are preferably connected to the central hydraulic system of the top carriage 39. By contrast with the embodiment illustrated in FIGS. 10-13, the tensioning cylinders 85 may also be disposed at the top end of the anchoring rods 19, namely between the anchoring rod 19 and free end of the co-operating lattice jib 83 respectively. This simplifies the connection of the tensioning cylinders 85 to the hydraulic system of the top carriage 39.

The control and/or regulating unit also has an inclination sensor for the tensioning cylinders 85, by means of which the actual status of the tower inclination can be determined whilst the crane is operating. The inclination sensor is preferably mounted on the top carriage 39, in which case the control and/or regulating unit is designed so that it works to achieve a horizontal orientation of a top carriage platform. Every tensioning cylinder 85 is provided with a distance measuring system. The system can always find a “zero position” serving as a reference point for positioning movements automatically with the aid of the inclination sensor by ensuring that the zero position of the tensioning cylinder 85 corresponds to said horizontal orientation of the top carriage 39.

The active anchoring system proposed by the invention is in a position to react immediately to changes in the tower inclination caused by changes in the load-induced bending moments acting on the tower 11, in which case the inclination sensor signals an associated change in inclination to the central control and/or regulating unit and corresponding positioning signals are calculated for the tensioning cylinders 85 on the basis of the amount and direction of the change in inclination and transmitted, on the basis of which the tensioning cylinders 85 are activated so that the tower 11 is “pulled” in the opposite direction accordingly.

Changes in the tower inclination are caused by changes in the size of the load, changes in the inclination of the jib 13 of the top carriage 39 and/or by changes in the rotational position of the top carriage 39.

The compensation control system proposed by the invention is fast enough to instigate the requisite change in the compensation direction, even when the top carriage 39 is rotating, because the tensioning cylinders 85 are activated to a certain extent “in real time” in order to effect correspondingly fast positioning movements.

If the jib 13 is disposed above a base stabiliser-lattice jib pair 17, 83, tensioning forces acting on the tower 11 are applied in the opposite direction virtually exclusively by the rod 19 tensioned between the diagonally opposite base stabiliser-lattice jib pair 17, 83, whilst the two adjacent tensioning cylinders 85 essentially assume only the function of providing lateral stability respectively. If, on the other hand, the jib 13 of the top carriage 39 is disposed between two guy anchors, the two rear tensioning cylinders 85 must pull on the tower 11 together in order to compensate for the instantaneous bending moment. The tensioning forces of the two tensioning cylinders 85 must be dimensioned so that the resultant tensioning force at least reduces the bending moment and moves the top carriage 39 at least essentially back into the pre-defined desired position.

This method of compensating load-induced bending moments proposed by the invention therefore works using a plurality of active guy anchors 17, 19, 83, 85 distributed around the tower 11, which can be activated independently of one another.

In the embodiment illustrated as an example, the anchoring rod linkages 19 fold in the manner of shear joints. Any configuration may be chosen for the guy anchors in the transport mode.

Instead of anchoring rods or rod linkages, it would also be possible to provide anchoring cables.

The lattice jib 83 may be secured to the top tower segment 31 by means of an auxiliary crane, for example, although this is not illustrated.

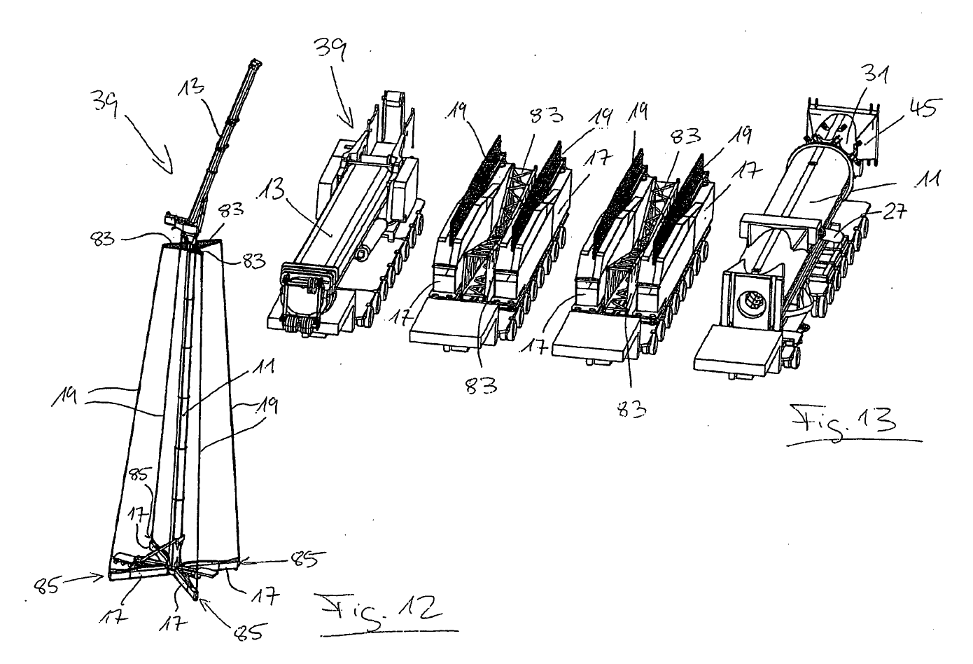

FIG. 13 illustrates one possible transport configuration for the vehicle mounted crane proposed by the invention for the embodiment described as an example above. Only four transport units are needed, one of which transports the top carriage 39, one the tower 11 and two others each transport two base stabilisers 17, including the co-operating anchoring rods 19 and lattice jib 83.

The invention therefore proposes a vehicle mounted crane which has a low overall weight relative to its carrying force and lifting capacity and which requires a small amount of space and is thus relatively quick and simple to transport on the roads and make ready for operation at the site. This results in an enormous reduction in the cost of using a crane.

In terms of its design and in particular the dimensions and weight of its constituent parts, the vehicle mounted crane proposed by the invention can be scaled to suit any requirements in principle. The vehicle mounted crane proposed by the invention is preferably designed so that it is suitable for erecting wind turbines.

In order to erect currently existing wind turbines, which have a hub height of approximately 85-100 m and for which the loads to be lifted are up to approximately 52 t, the tower 11 of one possible example of an embodiment has a weight of approximately 60 t and a length of approximately 70 m in the extracted state, whilst the weight of the top carriage 39 is approximately 60 t and its jib 13 has a length of approximately 60 m in the extracted state. The stabilising width of the star-shaped stabiliser system 17, i.e. the length of the base stabilisers in the extracted state, is approximately 18 m in each case.

Future wind turbines based on already existing plans will have a hub height of approximately 145 m and will requires loads in the order of 240 t to be lifted. Such wind turbines can be erected using the vehicle mounted crane proposed by the invention based on the described design and scaled accordingly without any problem. If necessary, the variant incorporating the counter-jib 37 described in connection with FIG. 8 or 9 may be used.

### LIST OF REFERENCE NUMBERS

11 Tower
13 Jib
15 Slewing unit
17 Stabiliser system, base stabiliser
19 Anchoring system, guy anchor, anchoring rod
21 Tower mount
23a Front bogie part
23b Rear bogie part
25 Retaining mechanism, rigid steering arm
27 First adjusting mechanism
29 Second adjusting mechanism
31 Top tower segment
33 Intermediate segment of the tower
35 Bottom tower segment
37 Counter-jib
39 Top carriage
41 Connection point
43 Forced guiding element
45 Head
47 Winch with brake mechanism
49 Stabiliser foot
53 Cab
55 Luffing unit
57 Tower of a wind turbine
59 Fixing point
61 Front piston end
65 Top mast segment
67 Intermediate segment of the jib mast
69 Bottom mast segment
71 Pivot axis for bottom tower end
73 Pivot axis between jib and tower
75 Luffing unit
77 Ballast
79 Anchoring system
81 Tensioning rod linkage, yoke
83 Jib for active anchoring system
85 Tensioning mechanism, tensioning cylinder
87 Stay cable

1. Vehicle mounted crane, in particular a mobile, self-propelled or crawler crane, with a super-structure provided in the form of a top-slewing system comprising a vertical tower (11) and a jib (13) mounted on the tower (11).

2. Vehicle mounted crane as claimed in claim 1,
characterised in that
the jib (13) is inclined with respect to the tower (11).

3. Vehicle mounted crane as claimed in claim 1,
characterised in that
the jib (13) is of an adjustable length, is preferably telescopic, and/or its angle can be adjusted relative to the tower (11).

4. Vehicle mounted crane as claimed in claim 1,
characterised in that
the tower (11) is of an adjustable length and is preferably telescopic.

5. Vehicle mounted crane as claimed in claim 1,
characterised in that
the intrinsic weight of the tower (11) is provided as a counter-weight.

6. Vehicle mounted crane as claimed in claim 1,
characterised in that
a stabiliser system (17) is provided for the tower (11), which preferably comprises a plurality of base stabilisers distributed around the tower (11).

7. Vehicle mounted crane as claimed in claim 6,
characterised in that
the intrinsic weight of the tower (11) and the stabiliser system (17) are adapted to one another so that no additional counter-weight is necessary.

8. Vehicle mounted crane as claimed in one of the preceding claims,
characterised in that
an anchoring system (19) is provided for the tower (11), which preferably comprises a plurality of anchoring elements distributed around the tower (11).

9. Vehicle mounted crane as claimed in claim 8,
characterised in that
the tower (11) is telescopic and the anchoring system (19) acts on one or more tower segments (31, 33, 35).

10. Vehicle mounted crane as claimed in claim 8,
characterised in that
the anchoring system (19) is anchored at least partially on a tower stabiliser system (17).

11. Vehicle mounted crane as claimed in claim 1,
characterised in that
an active anchoring system (19) is provided for the tower (11), which can be activated as a function of load-induced bending moments acting on the tower (11) in order to compensate these bending moments.

12. Vehicle mounted crane as claimed in claim 11,
characterised in that
the anchoring system (19) is disposed in a cross-shaped or star-shaped arrangement by reference to the tower axis.

13. Vehicle mounted crane as claimed in claim 11,
characterised in that
a control and/or regulating unit is provided, which constantly determines the degree and direction of compensation needed and activates the anchoring system (19) accordingly.

14. Vehicle mounted crane as claimed in claim 13,
characterised in that
the control and/or regulating unit has an inclination sensor.

15. Vehicle mounted crane as claimed in claim 11,
characterised in that
the anchoring system (19) acts on the tower (11) by means of tensioning forces in order to compensate the load-induced bending moments.

16. Vehicle mounted crane as claimed in claim 11,
characterised in that
the anchoring system (19) acts on the tower (11) on the one hand and on the tower stabiliser system (17) on the other hand.

17. Vehicle mounted crane as claimed in claim 11,
characterised in that
the anchoring system comprises a plurality of anchoring elements (19) distributed around the tower (11) which can be activated independently of one another.

18. Vehicle mounted crane as claimed in claim 17,
characterised in that
a jib (83) projecting out from the tower (11) is provided for every anchoring element (19), preferably in the form of a lattice part, by means of which the anchoring element (19) acts on the tower (11).

19. Vehicle mounted crane as claimed in claim 11,
characterised in that
the tower (11) is telescopic, the tower stabiliser system comprises a plurality of base stabilisers (17), in particular disposed in a cross-shaped or star-shaped arrangement, and a plurality of anchoring elements (19) of the anchoring system respectively act on a tower segment (31) on the one hand and on a base stabiliser (17) on the other hand.

20. Vehicle mounted crane as claimed in claim 17,
characterised in that
every anchoring element (19) is provided with a tensioning mechanism (85), in particular a tensioning cylinder, which is disposed between the anchoring element (19) and the tower (11) or between the anchoring element (19) and a tower stabiliser (17).

21. Vehicle mounted crane as claimed in claim 20,
characterised in that
every tensioning mechanism (85) is provided with a distance measuring system, by means of which the position of the tensioning mechanism (85) relative to a pre-defined base position can be determined.

22. Vehicle mounted claim as claimed in claim 1,
characterised in that
the jib (13) is provided with a counter-jib (37), and the counter-jib (37) can preferably be adjusted in order to vary the bending moment induced by it on the tower (11), and in particular has an adjustable length, namely is preferably telescopic and/or its angle can be adjusted relative to the tower (11).

23. Vehicle mounted crane as claimed in claim 22,
characterised in that
load-induced bending moments can be compensated by means of the counter-jib (37), preferably in such a way that the tower (11) is at least largely free of bending moments, and a control and/or regulating unit is preferably provided, by means of which the counter-jib (37) can be adjusted depending on the instantaneous load moment.

24. Vehicle mounted crane as claimed in claim 1,
characterised in that
a specifically pot-shaped or cup-shaped tower mount (21) is provided for the bottom end of the tower (11), which connects two bogie parts (23a, 23b) spaced apart to one another, and when the tower (11) is in the transport position, its bottom end is separated from the tower mount (21).

25. Vehicle mounted crane as claimed in claim 24,
characterised in that
the tower mount (21) is connected to a tower stabiliser system (17).

26. Vehicle mounted crane as claimed in claim 1,
characterised in that
the tower (11) is of a self-erecting design.

27. Vehicle mounted crane as claimed in claim 1,
characterised in that
in order to erect the tower (11), at least two length-adjustable adjusting mechanisms (27, 29) are provided, which act on positions spaced apart along the tower (11).

28. Vehicle mounted crane as claimed in claim 1,
characterised in that
the tower (11) can be transferred by means of a first adjusting mechanism (27) acting at a distance from the bottom tower end from an essentially horizontal transport position into an inclined position and by means of a second adjusting mechanism (29) acting in the region of the bottom tower end from the inclined position into the vertical working position, and the tower (11) is preferably forcibly guided in the region of its bottom end.

29. Vehicle mounted crane as claimed in claim 1,
characterised in that
the tower (11) can be erected with the jib (13) fitted, in particular the top carriage (39) incorporating the jib (13).

30. Vehicle mounted crane as claimed in claim 1,
characterised in that
a retaining mechanism (25) in the form of a rigid steering arm in particular is provided, which holds the angularly adjustable jib (13) fitted on the tower (11) in an at least approximately horizontal position during the erection operation irrespective of the tower inclination.

31. Vehicle mounted crane as claimed in claim 1,
characterised in that
the tower (11) disposed on a bogie (23a, 23b) in particular in the form of a flat-bed lorry on the one hand and the jib (13), in particular a top carriage (39) incorporating the jib (13) on the other hand are each provided with transport units which are specifically authorised to drive on roads.
